(19) United States
(12) Patent Application Publication
(10) Pub. No.: US 2013/0325907 A1
(43) Pub. Date: Dec. 5, 2013

(54) XML FILE CONVERSION TO FLAT FILE

(71) Applicants: Marcial E. Montes de Oca, Marlborough, MA (US); Irving A. J. Rivas Zarete, Santo Domingo (DO); Raúl Emile Vidal Alonzo, Santo Domingo (DO); Hector Saint-Hilaire, Waltham, MA (US)

(72) Inventors: Marcial E. Montes de Oca, Marlborough, MA (US); Irving A. J. Rivas Zarete, Santo Domingo (DO); Raúl Emile Vidal Alonzo, Santo Domingo (DO); Hector Saint-Hilaire, Waltham, MA (US)

(73) Assignee: VERIZON PATENT AND LICENSING INC., Basking Ridge, NJ (US)

(21) Appl. No.: 13/487,865

(22) Filed: Jun. 4, 2012

(51) Int. Cl. G06F 17/30

(52) U.S. Cl. 707/811; 707/E17.124

(57) ABSTRACT

A system obtains input report in Extensible Markup Language (XML) format and obtains a configuration file that includes a schema with output requirements for the input report. The system identifies, based on the configuration file, a parent node in the input report and reads records associated with the parent node. The system extracts data from the records associated with the parent node that correspond to the schema and generates, from the extracted data, an output report in a flat file format.

### BACKGROUND

Large organizations typically manage data structures that include information relating to multiple customers. These organizations may generate reports from the data structures that are designed for internal purposes, but are not well-suited for customer use.

### BRIEF DESCRIPTION OF THE DRAWINGS

FIG. 1 is a diagram illustrating concepts described herein;

FIG. 2 is a diagram illustrating an exemplary network in which systems and/or methods described herein may be implemented;

FIG. 3 is a block diagram of exemplary components of a device that may correspond to one of the devices of FIG. 2;

FIG. 4 is a block diagram of exemplary functional components of the enterprise server of FIG. 2;

FIG. 5 is a diagram of exemplary list of sub-processes that may be included in a customer configuration file;

FIG. 6 is a diagram of an exemplary process for generating a flat file from an Extensible Markup Language (XML) data file;

FIGS. 7A-7C illustrate an exemplary customer configuration file according to an implementation described herein;

FIG. 8 illustrates an exemplary XML input file according to an implementation described herein; and

FIG. 9 illustrates an exemplary flat format output file according to an implementation described herein.

### DETAILED DESCRIPTION OF PREFERRED EMBODIMENTS

The following detailed description refers to the accompanying drawings. The same reference numbers in different drawings may identify the same or similar elements.

Systems and/or methods described herein may obtain an input report in Extensible Markup Language (XML) format and obtain a configuration file including a schema that defines output requirements for the input report. The systems and/or methods may identify, based on the configuration file, a parent node in the input report and read records associated with the parent node. The systems and/or methods may extract data from the records, associated with the parent node, that correspond to the schema and generate, from the extracted data, an output report in a flat file format.

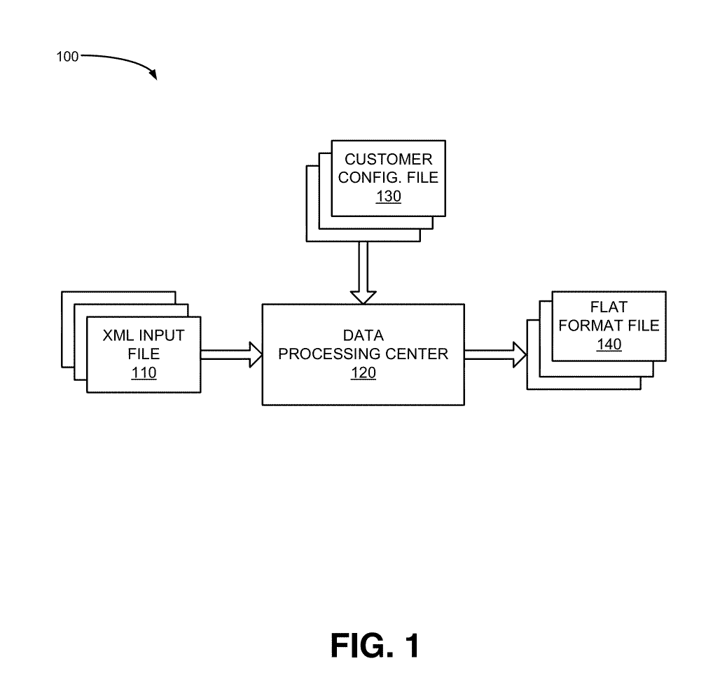

FIG. 1 is a diagram illustrating concepts described herein. XML input files 110 may be generated from a database. Each of XML input files 110 may represent, for example, a subset of information from the database that is relevant to a particular customer. Each XML input file may include, for example, a large number of records with numerous nested elements. XML input files 110 may provide an effective format for use by a service provider, but not necessarily for the customer. Customer configuration files 130 may provide configuration preferences for each customer. Configuration files 130 may include, for example, instructions for converting XML input files 110 into a flat format output file 140 (e.g., that is more useful to the customer) and, in some cases, enhancing/supplementing the input file data.

In implementations described herein, a data processing center 120 may receive XML input files 110 for particular customers and retrieve corresponding configuration file 130. Data processing center 120 may apply information from the retrieved configuration file 130 to a particular XML input file 110 to generate flat format file 140. Configuration files 130 may also provide instruction for enrichment, translations, calculations, and formatting when converting data from XML input files 110 to flat format output files 140. Enrichment of data may include, for example, data processing center 120 applying code plug-ins that provide specific functions and that can be dynamically invoked. The flat format file 140 may be, for example, a delineated file, a coma-separated values (CSV) file, or another plain text file that can be retrieved (e.g., by a respective customer) and imported into a variety of applications. Any of a variety of delimiters (e.g., tabs, commas, or another character or sequence of characters) for flat format file 140 may be included within flat format file 140 according to a schema (e.g., a schema included in one of configuration files 130). Particularly, flat format file 140 may provide a column and row format that can be viewed and/or manipulated using, for example, a spreadsheet application rather than a nested XML format.

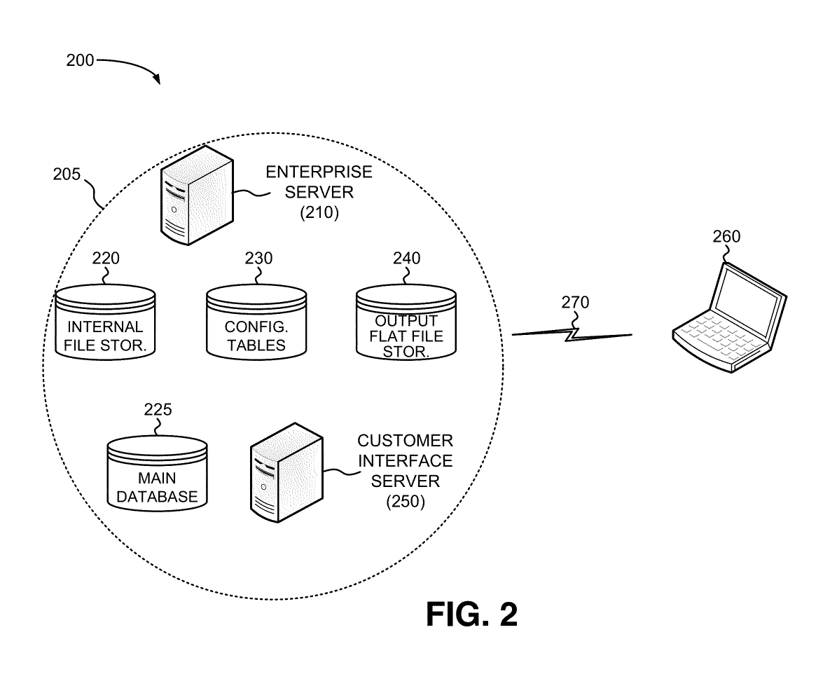

FIG. 2 is an exemplary network 200 in which systems and/or methods described herein may be implemented. As illustrated, network 200 may include a service provider network 205 and a customer device 260 interconnected by a network 270. Service provider network 205 may include an enterprise server 210, internal file storage 220, a main database 225, configuration tables 230, output flat file storage 240, and a customer interface server 250.

Service provider network 205 may generally include network devices to manage equipment and/or services, such as telecommunications equipment/services, to customers. Service provider network 205 may include a local area network (LAN), an intranet, a private wide area network (WAN), etc. In one implementation, service provider network 205 may implement one or more network connections or Virtual Private Network (VPN) connections for providing communication between, for example, any of enterprise server 210, internal file storage 220, configuration tables 230, output flat file storage 240, and customer interface server 250. Service provider network 205 may be protected/separated from other networks, such as network 270, by a firewall. Although shown as a single element in FIG. 2, service provider network 205 may include a number of separate networks.

Enterprise server 210 may include one or more server entities, or other types of computation or communication devices, that are capable of performing analysis and/or converting files stored, for example, in internal file storage 220. Enterprise server 210 may retrieve a data file (e.g., an XML file) from internal file storage 220 and a corresponding configuration table from configuration tables 230. Based on instructions in a configuration table, enterprise server 210 may analyze the data file and generate an output flat file (e.g., a CSV file). Enterprise server 210 may store the output flat file, for example, in output flat file storage 240.

Internal file storage 220 may include a database or another memory component to store files that are responsive to customer requests. For example, internal file storage 220 may include customer-specific information extracted from a larger database of multiple customers, such as main database 225. As a particular example, internal file storage 220 may include an XLM file, extracted from a configuration management database, with inventory information for a particular customer.

Main database 225 may include a database or another memory component to store data relating to multiple customers and/or systems. For example, main database 225 may include a configuration management database, inventory database, sales database, or another type of database from which reports (e.g., customer or system-specific reports) may be extracted.

Configuration tables 230 may include a database or another memory component to store files that provide configuration settings for different customers. For example, configuration tables 230 may include, for each customer, one or more XML files that define a flat file (e.g., CSV) structure, processing classes, and source data points for the particular customer. The files in configuration tables 230 may be generated by or for a customer before the customer places a request for information. For example, a configuration table for a particular customer may be generated and used to format repeated requests for information from internal file storage 220/main database 225.

Output flat file storage 240 may include a database or another memory component to store files generated by enterprise server 210. For example, output flat file storage 240 may store data files in CSV formats for particular customers (e.g., based on one or more files from internal file storage 220 and configuration tables 230). Files in output flat file storage 240 may be retrieved by customers (e.g., using customer device 260) via a secure communication protocol. In one implementation, output flat file storage 240 may include a shared platform that may permit customers to retrieve particular files using SSH File Transfer Protocol (SFTP) procedures.

Customer interface server 250 may include one or more server entities, or other types of computation or communication devices, to provide an interface to customers (e.g., customer device 260). In one implementation, customer interface server 250 may receive a request from customer device 260 to retrieve a particular file (e.g., an inventory file). The request may, for example, cause service provider network 205 to generate a responsive XML file for internal file storage 220. The responsive XML file may be used by enterprise server 210 to generate a corresponding flat file for output flat file storage 240. In another implementation, customer interface server 250 may provide a user interface to solicit information to generate a customer-specific configuration table to store in configuration tables 230.

Customer device 260 may include a computational or communication device. Customer device 260 may include, for example, a desktop computer, a laptop computer, a personal digital assistant (PDA), etc., used for general computing tasks. Customer device 260 may be configured to communicate with devices in service provider network 205 (e.g., via network 270).

Network 270 may include a local area network (LAN); an intranet; the Internet; a wide area network (WAN), such as a cellular network, a satellite network, a fiber optic network, a private WAN, or a combination of the Internet and a private WAN; etc., that is used to transport data. Although shown as a single element in FIG. 2, network 270 may include a number of separate networks that function to provide services to customer devices 260.

In FIG. 2, the particular arrangement and number of components of network 200 are illustrated for simplicity. In practice there may be more service provider networks 205, enterprise server 210, internal file storage 220, main databases 225, configuration tables 230, output flat file storage 240, customer interface server 250, customer devices 260, and/or networks 270. Components of system 200 may be connected via wired and/or wireless links.

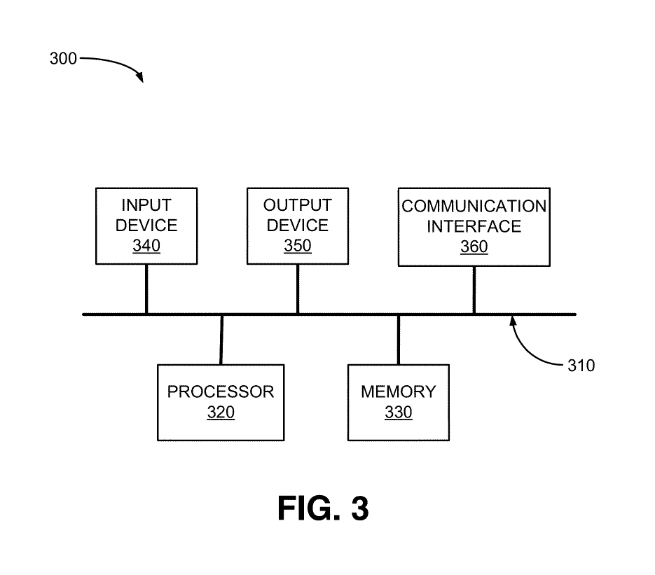

FIG. 3 is a diagram of exemplary components of a device 300. Each of enterprise server 210, device(s) of internal storage 220, device(s) of main database 225, device(s) on which configuration tables 230 are stored, customer interface server 250, and user device 260 may be implemented/installed as software, or a combination of hardware and software, on one or more of device 300. As shown in FIG. 3, device 300 may include a bus 310, a processor 320, a memory 330, an input device 340, an output device 350, and a communication interface 360.

Bus 310 may permit communication among the components of device 300. Processor 320 may include one or more processors or microprocessors that interpret and execute instructions. In other implementations, processor 320 may be implemented as or include one or more application specific integrated circuits (ASICs), field programmable gate arrays (FPGAs), or the like.

Memory 330 may include a random access memory (RAM) or another type of dynamic storage device that stores information and instructions for execution by processor 320, a read only memory (ROM) or another type of static storage device that stores static information and instructions for processor 320, and/or some other type of magnetic or optical recording medium and its corresponding drive for storing information and/or instructions.

Input device 340 may include a device that permits an operator to input information to device 300, such as a keyboard, a keypad, a mouse, a pen, a microphone, one or more biometric mechanisms, and the like. Output device 350 may include a device that outputs information to the operator, such as a display, a speaker, etc.

Communication interface 360 may include any transceiver-like mechanism that enables device 300 to communicate with other devices and/or systems. For example, communication interface 360 may include mechanisms for communicating with other devices, such as other devices of network 200.

As described herein, device 300 may perform certain operations in response to processor 320 executing software instructions contained in a computer-readable medium, such as memory 330. A computer-readable medium may include a non-transitory memory device. A memory device may be implemented within a single physical memory device or spread across multiple physical memory devices. The software instructions may be read into memory 330 from another computer-readable medium or from another device via communication interface 360. The software instructions contained in memory 330 may cause processor 320 to perform processes described herein. Alternatively, hardwired circuitry may be used in place of or in combination with software instructions to implement processes described herein. Thus, implementations described herein are not limited to any specific combination of hardware circuitry and software.

Although FIG. 3 shows exemplary components of device 300, in other implementations, device 300 may include fewer components, different components, differently arranged components, or additional components than those depicted in FIG. 3. As an example, in some implementations, a display may not be included in device 300. In these situations, device 300 may be a “headless” device that does not include input device 340. Alternatively, or additionally, one or more components of device 300 may perform one or more other tasks described as being performed by one or more other components of device 300.

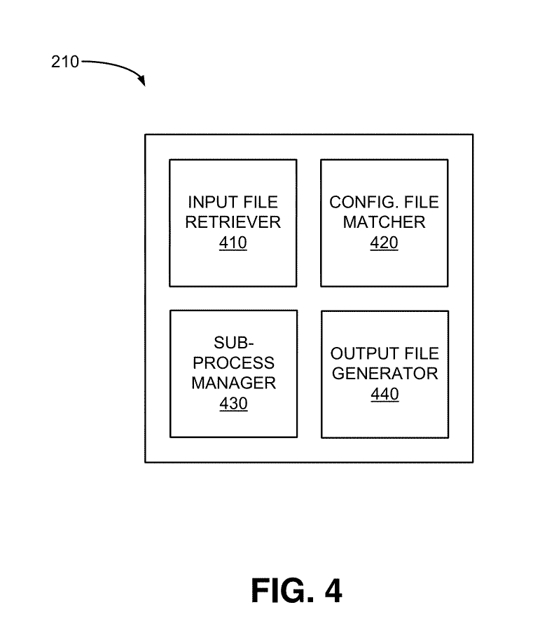

FIG. 4 is a block diagram of exemplary functional components of enterprise server 210. The functions described in connection with FIG. 4 may be performed by one or more components of FIG. 3. As shown in FIG. 4, enterprise server 210 may include an input file retriever 410, a configuration file matcher 420, a sub-process manager 430, and an output file generator 440.

Input file retriever 410 may include hardware and software components. In one implementation, input file retriever 410 may identify and retrieve a data file, such as an XML report file, for a particular customer. An internal file (e.g., an XML report) may be generated for example, in response to a customer inquiry and/or as part of a scheduled reporting procedure. Input file retriever 410 may retrieve the appropriate internal file (e.g., from internal file storage 220) associated with a particular customer.

Configuration file matcher 420 may include hardware and software components. In one implementation, configuration file matcher 420 may match a particular configuration file with a particular customer. For example, based on a customer identified in the internal file retrieved by input file retrieved 410, configuration file matcher 420 may find the appropriate configuration file from configuration tables 230 associated with the particular customer.

Sub-process manager 430 may include hardware and software components to process an internal file in relation to a particular customer configuration file. Generally, output file generator 440 may parse individual records of the internal file to convert each record into an output record. In one implementation, sub-process manager 430 may match class definitions and/or data manipulation processes in the customer configuration file with data elements from the input file. Each of the executed sub-process will modify the data from the vendor input file. Class definitions may be used, for example, to combine information from multiple fields (from an input file) into a single output field. Data manipulation processes (“data manipulators”) may match particular fields with processes (e.g., code plugins) to alter and/or enhance data from the input file. For example, sub-process manager 430 may convert data (e.g., from English to metric units), map one type of data to another (e.g., using a lookup table, dictionary, etc.), or perform other data manipulations. According to an implementation herein, sub-process types may include, for example, primary, xpath, mxpath, constant, conca, list, and translate. Each of the executed sub-processes may return a true/false indicator as a signal to continue the process for the current element or to abort to the next element.

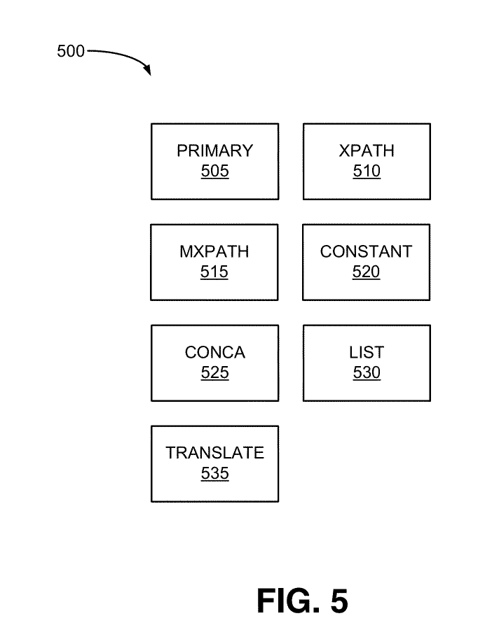

Names of sub-processes 500 that may be included in customer configuration files 130 and may be executed by sub-process manager 430 are described further in connection with FIG. 5. As shown in FIG. 5, sub-processes 500 may include a primary process 505, an xpath process 510, an mxpath process 515, a constant process 520, a concatenation process 525, a list process 530, and a translate process 535.

Primary process 505 may find a primary key element and may determine if the primary key element is a duplicate. A primary key element may include, for example, a data item of interest to a customer and to which other data fields may relate. As an example, a primary key may include information about a particular router with other relating data fields including a name, manufacturer, installation location, configuration, lifecycle status, stock number, etc. Primary process 505 may detect duplicate elements and exclude the duplicate elements from the output report. If not a duplicate, the primary key element may be processed for insertion into the output file.

Xpath process 510 may find a designated element in the XML input file (e.g., XML input file 800). These elements may repeat through parent node detail records. Mxpath process 515 may find a designated element in the XML/MXML input file (e.g., XML input file 700). These elements are considered the detail record for the parent node.

Constant process 520 may insert a designated value as a constant repeating through all records of the parent node. For example, constant process 520 may provide a designated customer prefix, group name, etc. associated with a particular field.

Concatenation process 525 may allow concatenation of values in a single field. Concatenation process 525 may use field types from other processes, such as constant, translate, xpath, and/or xmpath to form, for example, a single string value.

List process 530 may create a comma separated list with the result of the provided xpath into a quoted field. List process 530 may assume multiple results are returned from an xpath process.

Translate process 535 may provide a value to value mapping with the use of a mapping table or dictionary. For example, translate process 535 may match a value (e.g., a vendor stock number) from an input file to a corresponding customer value that may not be available in main database 225 (e.g., a customer part number). The mapping table or dictionary may be included, for example, within configuration tables 230 or a separate database.

Although FIG. 5 shows exemplary sub-processes 500 that may be executed by sub-process manager 430, in other implementations, sub-processes 500 may include fewer, different, differently-arranged, or additional processes than those depicted in FIG. 5. Alternatively, or additionally, one or more sub-processes 500 may perform one or more other tasks described as being performed by one or more other sub-processes 500.

Referring again to FIG. 4, output file generator 440 may include hardware and software components to generate a flat file (e.g., an output file) in accordance with customer preferences. For example, output file generator 440 may collect and compile results from sub-process manager 430 to create individual CSV records and compile an output file based on the schema data. The output file may be formatted to delineate columns/rows associated with particular elements and rows/columns corresponding to fields for the particular elements

Although FIG. 4 shows exemplary functional components of enterprise server 210, in other implementations, enterprise server 210 may include fewer, different, differently-arranged, or additional functional components than those depicted in FIG. 4. Alternatively, or additionally, one or more functional components of enterprise server 210 may perform one or more other tasks described as being performed by one or more other functional components of enterprise server 210.

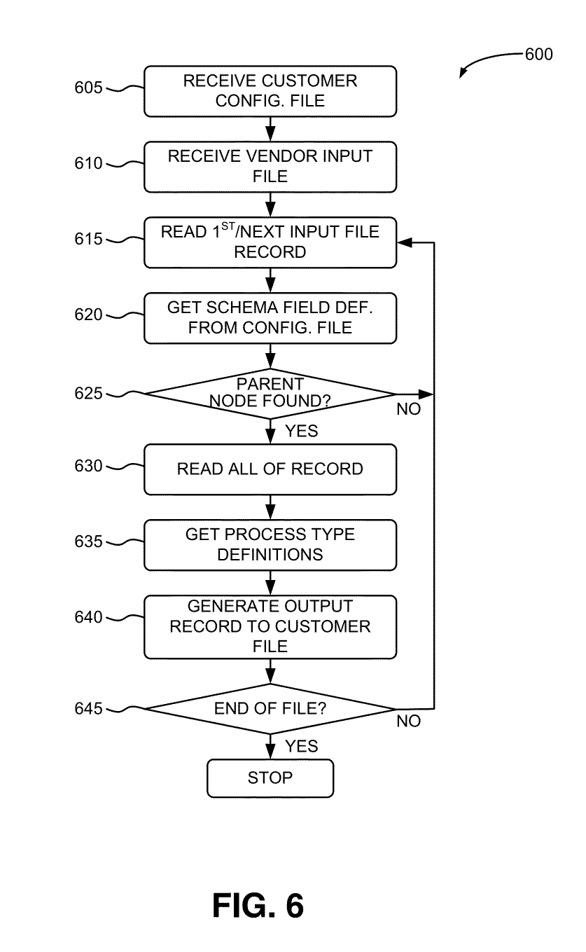

FIG. 6 is a diagram of an exemplary process 600 for generating a flat file from an XML data file. In one implementation, process 600 may be performed by enterprise server 210. In another implementation, some or all of process 600 may be performed by another device or group of devices, including or excluding enterprise server 210. For example, another device in service provider network 205 may perform one or more parts of process 600.

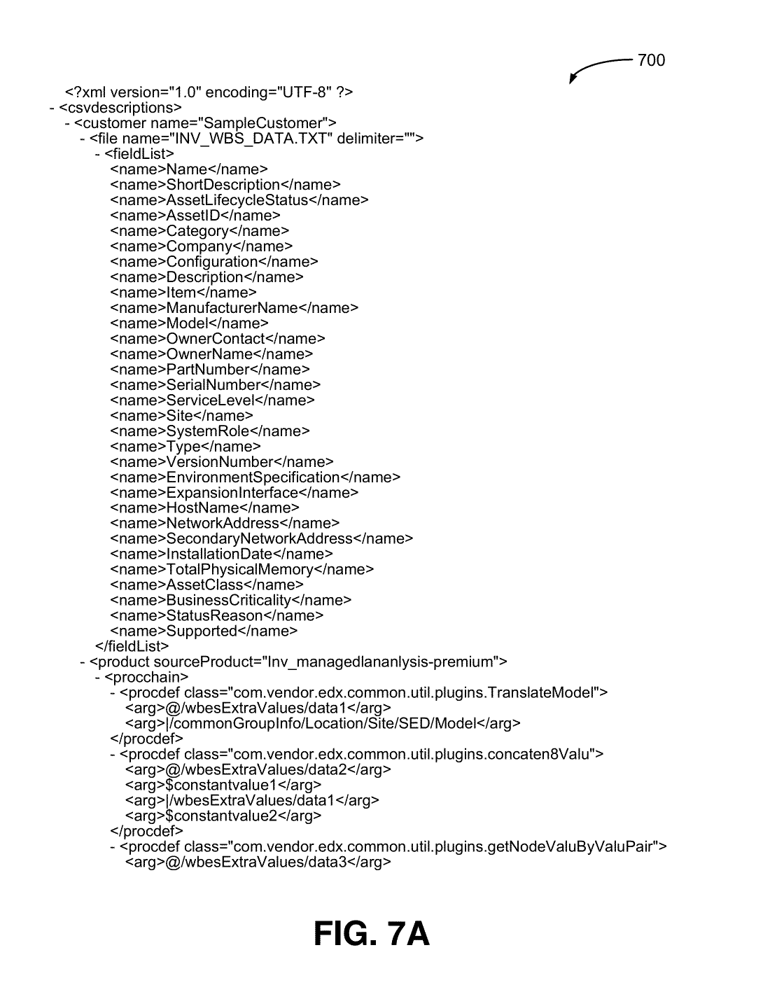

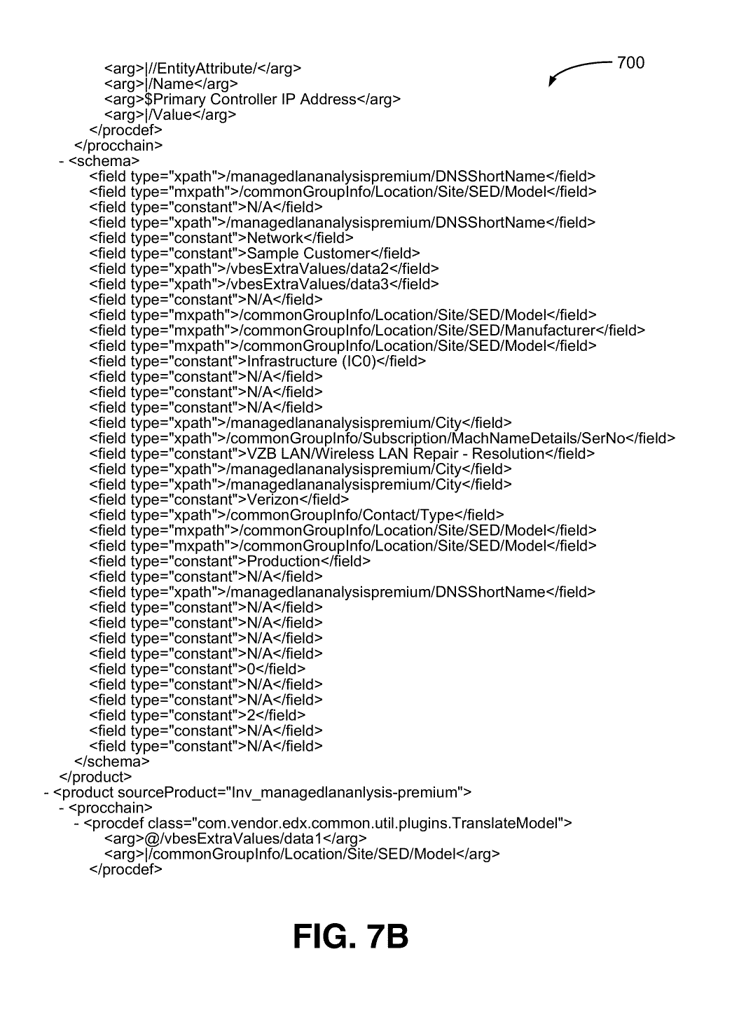

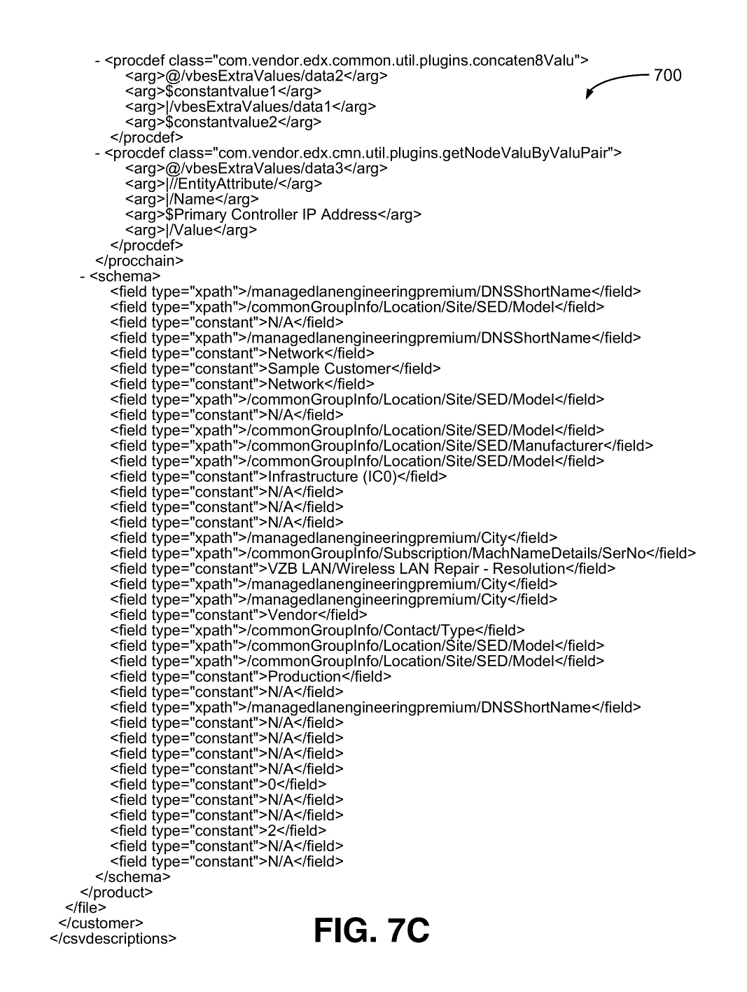

As shown in FIG. 6, process 600 may include receiving a customer configuration file (block 605). For example, enterprise server 210 (e.g., configuration file matcher 420) may obtain (e.g., from configuration tables 230) an XML file that defines a CSV structure, processing classes, and source data points for generating a flat file from an XML report file. An exemplary customer configuration file 700 is included in FIGS. 7A-7C. Customer configuration file 700 may correspond to, for example, one of customer configuration files 130 of FIG. 1. As shown in FIGS. 7A-7C, customer configuration file 700 may include an XML schema that identifies a file name (e.g., “INV_WBS_DATA.TXT”) to create for the customer, what attributes (e.g., “fieldList”) the customer wants to extract from an XML input file, a parent node (e.g., product sourceProduct=“Inv_managedlananlysis-premium”) to which the attributes are associated, processes that may be performed to translate and/or enhance data (e.g., “<prochain>”), and a schema for the parent node. A parent node may correspond to, for example, a particular product or a service in the input file that may have multiple items and/or features. For example, in customer configuration file 700, the parent node may correspond to a network service (e.g., a LAN management service) that includes numerous network devices.

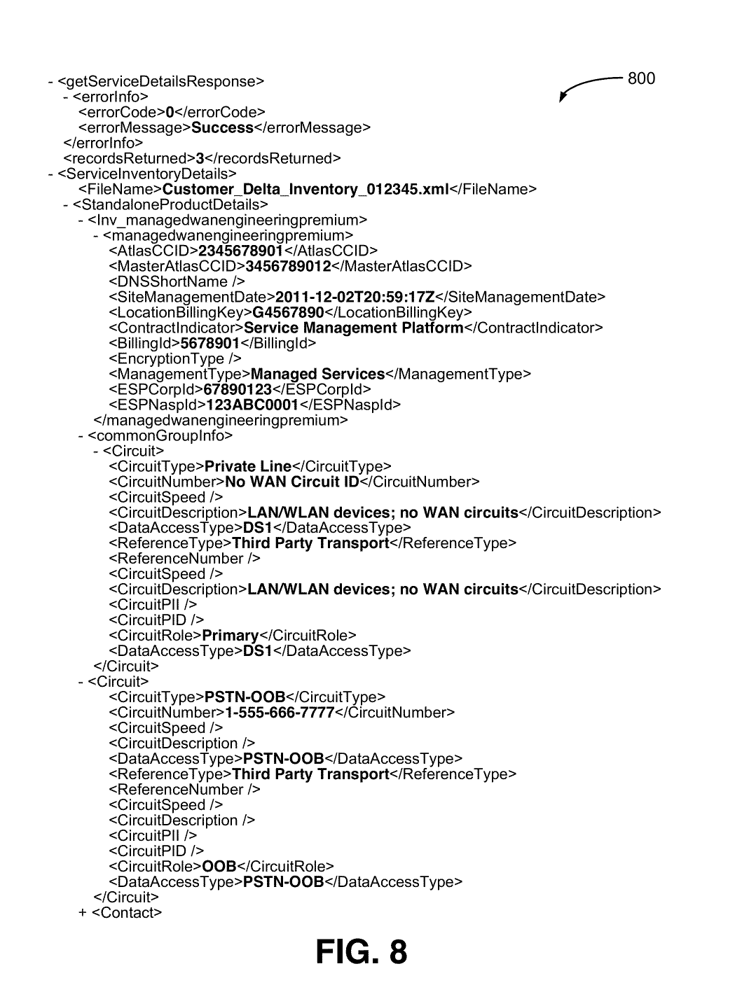

Process 600 may also include receiving a vendor input file (block 610). For example, enterprise server 210 (e.g., input file retriever 410) may receive a data file, such as an XML report file, for a particular customer. A portion of an exemplary XML input file 800 is included in FIG. 8. XML input file 800 may correspond to, for example, one of XML input files 110 of FIG. 1. As shown in FIG. 8, XML input file 800 may include inventory information for telecommunications services for a particular customer. The inventory information may include nested elements for numerous products. In other implementations, XML input file 800 may include data for different systems and/or initiatives. The input file may have multiple records (e.g., representing multiple parent nodes).

A first input file record may be read (block 615) and the schema field definition may be retrieved from the configuration file (block 620). For example, enterprise server 210 (e.g., sub-process manager 430) may identify a first record in vendor input file 800. Enterprise server 210 may then match the record with a corresponding schema from configuration file 700. As shown in FIG. 7B, a schema for the parent node “Inv_managedlananlysis-premium” may identify field types for different fields in main database 225 (e.g., that are included in vendor input file 800).

It may be determined if a parent node is found in the in the input file record (block 625). For example, enterprise server 210 may determine if the XML input file 800 includes the parent node indicated in customer configuration file 700. The parent node must be in the list of products from configuration file 700 to be included in the eventual flat file output generated by enterprise server 210. If the parent node is not found in the input file record (block 625—NO), process 600 may return to block 615 to read a next input file record.

If the parent node is found in the input file record (block 625—YES), process 600 may read all of the parent node record (block 630). For example, enterprise server 210 (e.g., input file retriever 410) may extract an entire sub-XML section (e.g., relating to the parent node) from XML input file 800 for processing independently.

Process 600 may further include obtaining process type definitions (block 635). For example, enterprise server 210 (sub-process manager 430) may get a list of classes and data manipulators from customer configuration file 700. Class definitions may be used, for example, to combine information from multiple fields (from input file 800) into a single output field. Data manipulators may match particular fields with processes (e.g., code plugins) to alter and/or enhance data from input file 800. In the implementation of FIGS. 7A-7C, classes may be indicated by extending a plugin name (e.g., “<procdef class=‘com.vendor.edx.common.util. plugins.TranslateModel’”) with an ‘execute’ method that receives a product element from XML input file 800, a configuration element from customer configuration file 700, and an array string for configurable arguments.

An output record may be generated to a customer file (block 640). For example, enterprise server 210 (e.g., output file generator 440) may generate a CSV record to a file (e.g., “INV_VBS_DATA.TXT”) based on the schema data. In one implementation, the output file may be formatted to delineate columns associated with particular elements and rows corresponding to fields for the particular elements. In another implementation, the output file may be formatted to delineate rows associated with particular elements and columns corresponding to fields for the particular elements. The output file may be stored, for example, in output flat file storage 240 or another location where the output file can be retrieved by the customer.

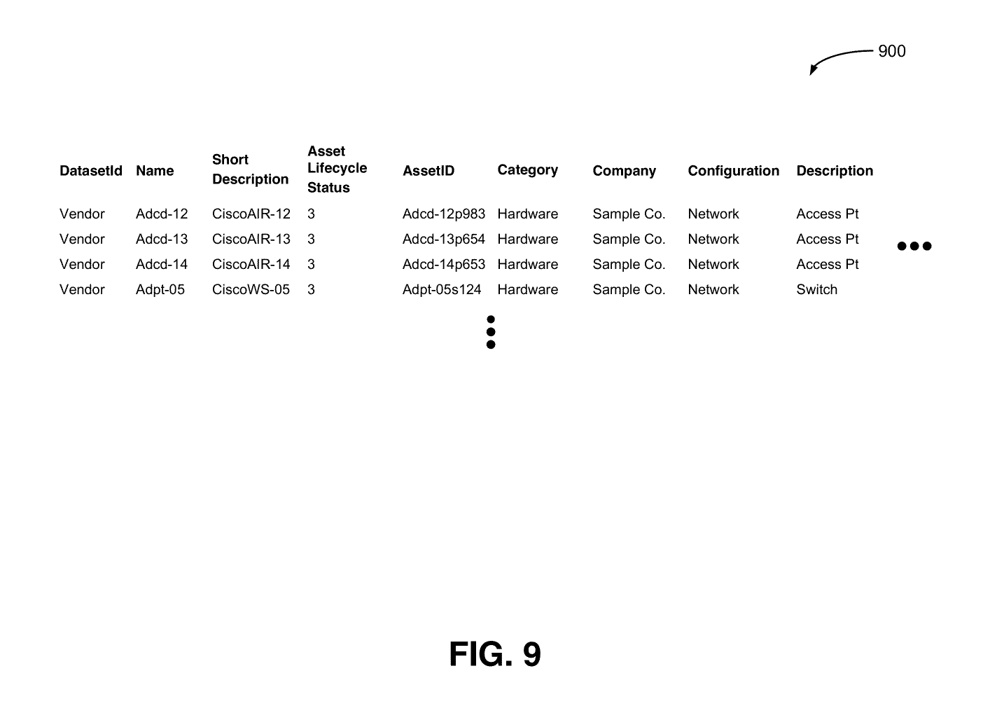

A portion of an exemplary flat format output file 900 is included in FIG. 9. Flat format output file 900 may correspond to, for example, one of flat format files 140 of FIG. 1. As shown in FIG. 9, flat format output file 900 may include data extracted from an input file (e.g., XML input file 800) and formatted according to a particular customer format defined in a configuration file (e.g., customer configuration file 700). Flat format output file 900 may, for example, include field headings defined in customer configuration file 700 (e.g., “Datasetld,” “Name,” “Short Description,” etc.). Fields in flat format output file 900 may be populated with data extracted from XML input file 800 and/or enriched by processes in customer configuration file 700. In one implementation, flat format output file 900 may be provided as a CSV text file.

Returning to FIG. 6, it may be determined if another input file record exists (block 645). If more input file records are available (block 645—NO), process 600 may return to block 615 to read a next input file record. If no other input file records are available (block 645-YES), process 600 may end.

As described above, systems and/or methods may convert an XML report file into a flat output file format according to customer preferences. The systems and/or methods may also perform additional processing to provide an output file with enriched data beyond the original XML report file. In one implementation, the systems and/or methods may retrieve, one or more remote systems, an XML input report and a configuration file including a schema that defines output requirements for a particular customer. The systems and/or methods may identify, based on the configuration file, a parent node in the input report, read records associated with the parent node, and extract data from the records associated with the parent node that correspond to the schema. The systems and/or methods may generate an output file, for the particular customer, that includes the extracted data in a delimited file format.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. For example, while a series of blocks has been described with respect to FIG. 6, the order of the blocks may be modified in other implementations. Further, non-dependent blocks may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware can be designed to implement these aspects based on the description herein.

Further, certain portions of the invention may be implemented as a “component” or “system” that performs one or more functions. These components/systems may include hardware, such as a processor, an ASIC, or a FPGA, or a combination of hardware and software.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

1. A method, comprising:
obtaining, by a computing device and from a group of multiple configuration files, a configuration file for a particular customer, wherein the configuration file for the particular customer defines output requirements for an input report, and wherein the output requirements include a particular file name for an output report name, a list of attributes to extract from the input report, a parent node to which the attributes are associated, and one or more processes to enhance data from the input report;
extracting, by the computing device and from an Extensible Markup Language (XML) database of information of multiple customers, the input report for the particular customer, wherein the input report is a separate file in XML format that is independent of the XML database;
identifying, by the computing device and based on the configuration file, the parent node in the input report;
reading, by the computing device, records associated with the parent node;
extracting, by the computing device, the data from the records associated with the parent node that correspond to the attributes;
applying, by the computing device and to the data, the one or more processes to enhance the data from the input report;
generating, by the computing device, an output report in a flat file format, wherein the output report includes the particular file name, the extracted data, and the enhanced data designated by the configuration file for the particular customer; and
storing, by the computing device, the output report to a shared platform for customer access.

2. The method of claim 1, wherein the parent node includes multiple components that indicate a product or service.

3. The method of claim 1, wherein applying the one or more processes includes performing a translation process to map an item from the data to a corresponding customer value that is not in the XML database of information of multiple customers.

4. The method of claim 1, wherein the configuration file includes XML instructions to define a comma-separated values (CSV) structure for the output report.

5. The method of claim 1, wherein the configuration file further includes logic to exclude duplicate elements from the output report.

6. The method of claim 1, wherein applying the one or more processes includes combining one or more values from the extracted data into a single field.

7. The method of claim 1, further comprising:
mapping, based on another data structure, values from the input report to different values for the output report.

8. The method of claim 1, wherein the output file includes a delimited file.

9. The method of claim 8, wherein the delimited file is determined according to a schema that indicates a particular delimiter.

10. The method of claim 9, wherein the delimited file delineates rows associated with particular elements of the input report and columns corresponding to fields for the particular elements.

11. The method of claim 9, wherein the delimited file delineates columns associated with particular elements of the input report and rows corresponding to fields for the particular elements.

12. A non-transitory computer-readable medium comprising computer-executable instructions, the computer-readable medium comprising one or more instructions to:
obtain, from a group of multiple configuration files, a configuration file for a particular customer, wherein the configuration file for the particular customer defines output requirements for an input report, and wherein the output requirements include a particular file name for an output report name, a list of attributes to extract from the input report, a parent node to which the attributes are associated, and one or more processes to enhance data from the input report;
extract, from an Extensible Markup Language (XML) database of information of multiple customers, the input report for the particular customer, wherein the input report is a separate file in XML format that is independent of the XML database;
identify, based on the configuration file, the parent node in the input report;
read records associated with the parent node;
extract the data, from the records associated with the parent node, that corresponds to the attributes;
apply, to the data, the one or more processes to enhance the data from the input report; and
generates an output report in a flat file format, wherein the output report includes the particular file name, the extracted data, and the enhanced data designated by the configuration file for the particular customer.

13. The computer-readable medium of claim 12, further comprising one or more instructions to:
store the output report in a database accessible by a customer via a secure communication protocol.

14. The computer-readable medium of claim 12, further comprising one or more instructions to:
access a data structure including a cross-reference of input values and output values, and
map values in the input report to different values for the output report based on the data structure.

15. The computer-readable medium of claim 12, wherein the input report includes a database report for a particular customer, and wherein the one or more instructions to read records associated with the parent node further comprise one or more instructions to:
extract, from the database, a complete XML segment for the parent node.

16. The computer-readable medium of claim 12, wherein the output report includes a delimited file based on the configuration file for the particular customer.

17. The computer-readable medium of claim 16, wherein the delimited file delineates one of:
rows associated with particular elements and columns corresponding to fields for the particular elements, or
columns associated with particular elements and rows corresponding to fields for the particular elements.

18. A computing device, comprising:
a network interface to communicate with one or more remote systems including an Extensible Markup Language (XML) database of information of multiple customers;
one or more memories to store instructions; and
one or more processors configured to execute instructions in the one or more memories to:
retrieve, from the one or more remote systems, an input report, for a particular customer in XML format, wherein the input report is a separate file that is independent of the XML database,
retrieve, from the one or more remote systems, a configuration file for the particular customer, wherein the configuration file for the particular customer defines output requirements for the input report, and wherein the output requirements include a particular file name for an output report name, a list of attributes to extract from the input report, a parent node to which the attributes are associated, and one or more processes to enhance data from the input report,
identify, based on the configuration file, the parent node in the input report,
read records associated with the parent node,
extract the data from the records associated with the parent node that correspond to the attributes,
apply, to the data, the one or more processes to enhance the data from the input report; and
generate an output file, for the particular customer, that includes the extracted data in a delimited file format, wherein the output report includes the particular file name, the extracted data, and the enhanced data designated by the configuration file for the particular customer.

19. The computing device of claim 18, wherein the one or more processors are further configured to:
store, in the one or more remote systems, the output file that is accessible to the particular customer via a secure communications protocol.

20. The computing device of claim 18, wherein, when extracting the data, the one or more processors are further configured to:
include concatenated values from the input report in a single field.

21. The computing device of claim 18, wherein the one or more processors are further configured to:
access a data structure including a cross-reference of input values and output values, and
map values in the input report to different values for the output report based on the data structure.
